(19) United States
(12) Patent Application Publication
(10) Pub. No.: US 2022/0161810 A1
(43) Pub. Date: May 26, 2022

(54) DRIVING ASSISTANCE DEVICE AND DRIVING ASSISTANCE METHOD

(71) Applicant: Mitsubishi Electric Corportion, Tokyo (JP)

(72) Inventor: Yoshihiko MORI, Tokyo (JP)

(73) Assignee: Mitsubishi Electric Corportion, Tokyo (JP)

(21) Appl. No.: 17/433,010

(22) PCT Filed: Mar. 11, 2019
(86) PCT No.: PCT/JP2019/009688

§ 371 Date: Aug. 23, 2021

(51) Int. Cl. B60W 50/04; G05B 13/02

(52) U.S. Cl. CPC B60W 50/045; G05B 13/0265; B60W 50/0205; B60W 2555/20; B60W 2050/041

(57) ABSTRACT

A sensor acquisition unit acquires an output result of a sensor mounted in a vehicle. An arithmetic unit uses a machine learning algorithm in which the output result of the sensor acquired by the sensor acquisition unit is set as an input, to calculate an inference result for controlling the vehicle. A degree of reliability estimation unit determines the degree of similarity between the output result acquired by the sensor acquisition unit and training data which has been used for learning of the machine learning algorithm, and estimates the degree of reliability of the inference result calculated by the arithmetic unit on the basis of the degree of similarity. A control output unit adds the degree of reliability estimated by the degree of reliability estimation unit to the inference result calculated by the arithmetic unit, and outputs the inference result with the degree of reliability as vehicle control information.

### TECHNICAL FIELD

The present disclosure relates to a driving assistance device and a driving assistance method for vehicles.

### BACKGROUND ART

Conventional driving assistance devices perform machine learning of a correspondence between information acquired from a sensor mounted in a vehicle and assistance information for controlling the vehicle. Such conventional driving assistance devices evaluate the reliability of the assistance information on the basis of the reliability of the sensor (for example, refer to Patent Literature 1).

### CITATION LIST

### Patent Literature

Patent Literature 1: JP 2015-82324 A

### SUMMARY OF INVENTION

### Technical Problem

In conventional driving assistance devices, an arithmetic operation which a machine learning algorithm performs is a black box, and the assistance information outputted by the machine learning algorithm is based on the premise that the assistance information has a uniform degree of reliability. Because conventional driving assistance devices do not evaluate the degree of reliability of the assistance information outputted by the machine learning algorithm, as mentioned above, there is a problem that there is a possibility that the vehicle makes an unexpected behavior on the basis of the assistance information having a low degree of reliability.

The present disclosure is made in order to solve the above-mentioned problem, and it is therefore an object of the present disclosure to provide a technique of preventing an unexpected behavior of a vehicle because of machine learning from occurring.

### Solution to Problem

A driving assistance device according to the present disclosure includes: a sensor acquisition unit for acquiring an output result of a sensor mounted in a vehicle; an arithmetic unit for using a machine learning algorithm in which the output result acquired by the sensor acquisition unit is set as an input, to calculate an inference result for controlling the vehicle; a degree of reliability estimation unit for estimating a degree of reliability of the inference result calculated by the arithmetic unit; and a control output unit for adding the degree of reliability estimated by the degree of reliability estimation unit to the inference result calculated by the arithmetic unit, and outputting the inference result with the degree of reliability as vehicle control information.

### Advantageous Effects of Invention

According to the present disclosure, because the degree of reliability of the inference result calculated using the machine learning algorithm in which the output result of the sensor acquisition unit is set as an input is estimated, the occurrence of an unexpected behavior of the vehicle because of the machine learning can be suppressed.

### BRIEF DESCRIPTION OF DRAWINGS

FIG. 1 is a block diagram showing an example of the configuration of a driving assistance device according to Embodiment 1;

FIG. 2 is a flowchart showing an example of operations of the driving assistance device according to Embodiment 1;

FIG. 3 is a block diagram showing an example of the configuration of a driving assistance device according to Embodiment 2;

FIG. 4 is a diagram showing an example of the configuration of a multilayer neural network which an arithmetic unit has in Embodiment 2;

FIG. 5 is a flowchart showing an example of operations of the driving assistance device according to Embodiment 2;

FIG. 6 is a relative frequency distribution graph showing an example of a distribution of an inference result in Embodiment 2;

FIG. 7 is a block diagram showing an example of the configuration of a driving assistance device according to Embodiment 3;

FIG. 8 is a flowchart showing an example of operations of the driving assistance device according to Embodiment 3;

FIG. 9 is a block diagram showing an example of the configuration of a driving assistance device according to Embodiment 4;

FIG. 10 is a flowchart showing an example of operations of the driving assistance device according to Embodiment 4;

FIG. 11 is a diagram showing an example of the hardware configuration of the driving assistance device according to each of the embodiments; and

FIG. 12 is a diagram showing another example of the hardware configuration of the driving assistance device according to each of the embodiments.

### DESCRIPTION OF EMBODIMENTS

Hereinafter, in order to explain the present disclosure in greater detail, embodiments of the present disclosure will be described with reference to the accompanying drawings.

### Embodiment 1

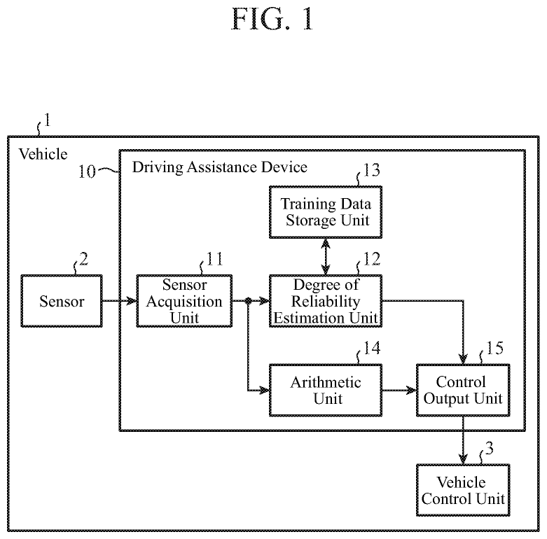

FIG. 1 is a block diagram showing an example of the configuration of a driving assistance device 10 according to Embodiment 1. A sensor 2, a vehicle control unit 3, and the driving assistance device 10 are mounted in a vehicle 1. The driving assistance device 10 includes a sensor acquisition unit 11, a degree of reliability estimation unit 12, a training data storage unit 13, an arithmetic unit 14, and a control output unit 15. The sensor 2 and the vehicle control unit 3 are connected to this driving assistance device 10.

The sensor 2 detects a surrounding environment of the vehicle 1. This sensor 2 is, for example, a camera for capturing an image of an area in the vicinity of the vehicle 1 or a millimeter wave radar for detecting an object existing in the vicinity of the vehicle 1. The sensor 2 is not limited to a single sensor or a single type of sensor, and may include two or more sensors or two or more types of sensors.

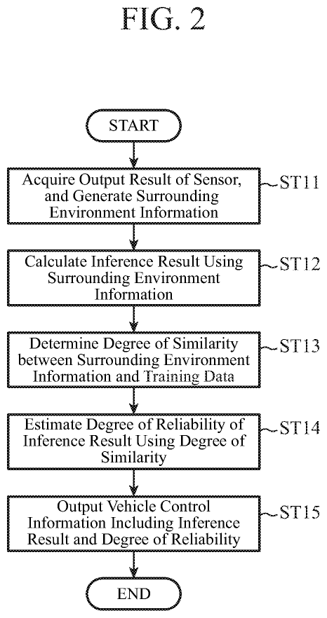

FIG. 2 is a flowchart showing an example of operations of the driving assistance device 10 according to Embodiment 1. The driving assistance device 10 starts the operations shown in the flowchart of FIG. 2 when, for example, the ignition switch of the vehicle 1 is turned on, and repeats the operations until the ignition switch is turned off.

In step ST11, the sensor acquisition unit 11 acquires information detected by the sensor 2, and generates surrounding environment information indicating the surrounding environment of the vehicle 1 by integrating the acquired information. The sensor acquisition unit 11 outputs the surrounding environment information to the degree of reliability estimation unit 12 and the arithmetic unit 14. The surrounding environment information is information which makes it possible to recognize the states of other vehicles, pedestrians or the likes existing in the vicinity of the vehicle 1, geographical features or the likes in the vicinity of the vehicle 1, and obstacles or the likes. Further, the surrounding environment information maybe raw data outputted by the sensor 2 or information which is abstracted by performing a certain process on the raw data. The abstracted information is, for example, a chart in which surrounding objects or the likes are plotted in a coordinate system corresponding to space in the vicinity of the vehicle 1.

In step ST12, the arithmetic unit 14 calculates an inference result for controlling the vehicle 1 by using a machine learning algorithm in which the surrounding environment information from the sensor acquisition unit 11 is set as an input. The machine learning algorithm is, for example, a neural network or a multilayer neural network (deep learning). The inference result is, for example, the stepping amount of the brake or the accelerator, or the steering angle of the steering wheel. The arithmetic unit 14 outputs the calculated inference result to the control output unit 15.

In step ST13, the degree of reliability estimation unit 12 compares the surrounding environment information from the sensor acquisition unit 11 with training data stored in the training data storage unit 13, to determine the degree of similarity between them. The training data storage unit 13 stores the training data which has been used during learning of the machine learning algorithm which the arithmetic unit 14 has.

For example, the degree of reliability estimation unit 12 calculates a feature quantity of the training data by performing statistical processing on the training data. Similarly, the degree of reliability estimation unit 12 calculates a feature quantity of the surrounding environment information by also performing the statistical processing on the surrounding environment information. The degree of reliability estimation unit 12 then calculates a correlation value between the feature quantity of the training data and the feature quantity of the surrounding environment information, and defines the correlation value as the degree of similarity. The statistical processing for calculating a feature quantity is, for example, a process of calculating an average or a dimensional compression process using AutoEncoder. The training data storage unit 13 may store, instead of the training data, the feature quantity of the training data.

In step ST14, on the basis of the degree of similarity between the training data and the surrounding environment information, the degree of reliability estimation unit 12 estimates the degree of reliability of the inference result which the arithmetic unit 14 has calculated using the surrounding environment information. The degree of reliability estimation unit 12 outputs the estimated degree of reliability to the control output unit 15.

The higher the degree of similarity, the higher degree of reliability of the inference result the degree of reliability estimation unit 12 estimates. For example, the degree of reliability estimation unit 12 estimates a degree of reliability of discrete type (e.g., a degree of reliability ranging from level 1 to level 5) by making a comparison between the degree of similarity and a predetermined threshold. As an alternative, the degree of reliability estimation unit 12 may perform a polynomial transformation process on the degree of similarity, to estimate a degree of reliability of continuous type (e.g., a degree of reliability ranging from 0% to 100%).

In step ST15, the control output unit 15 adds the degree of reliability from the degree of reliability estimation unit 12 to the inference result from the arithmetic unit 14, to generate vehicle control information. The control output unit 15 outputs the vehicle control information to the vehicle control unit 3.

The vehicle control unit 3 controls the behavior of the vehicle 1 using the inference result included in the vehicle control information from the control output unit 15. The vehicle control unit 3 changes the control in accordance with the degree of reliability added to the inference result. For example, when the degree of reliability is equal to or greater than a predetermined threshold, the vehicle control unit 3 controls the behavior of the vehicle 1 using the inference result to which this degree of reliability is added, whereas when the degree of reliability is less than the above-mentioned predetermined threshold, the vehicle control unit 3 discards the inference result to which this degree of reliability is added, and does not perform any behavior control.

As mentioned above, the driving assistance device 10 according to Embodiment 1 includes the sensor acquisition unit 11, the arithmetic unit 14, the degree of reliability estimation unit 12, and the control output unit 15. The sensor acquisition unit 11 acquires an output result of the sensor 2 mounted in the vehicle 1. The arithmetic unit 14 calculates an inference result for controlling the vehicle 1 by using the machine learning algorithm in which the output result of the sensor 2 acquired by the sensor acquisition unit 11 is set as an input. The degree of reliability estimation unit 12 determines the degree of similarity between the output result acquired by the sensor acquisition unit 11 and the training data which has been used for the learning of the machine learning algorithm, and estimates the degree of reliability of the inference result calculated by the arithmetic unit 14 on the basis of the degree of similarity. The control output unit 15 adds the degree of reliability estimated by the degree of reliability estimation unit 12 to the inference result calculated by the arithmetic unit 14, and outputs the inference result with the degree of reliability as vehicle control information. With this configuration, the driving assistance device 10 can estimate the degree of reliability of the inference result of the machine learning algorithm. Therefore, when the degree of reliability of the inference result of the machine learning algorithm is low because of insufficient learning or the like, the driving assistance device 10 can suppress the occurrence of an unexpected behavior of the vehicle 1.

Further, according to Embodiment 1, the degree of reliability estimation unit 12 may determine the degree of similarity between a feature quantity of the output result of the sensor 2 acquired by the sensor acquisition unit 11 and a feature quantity of the training data. With this configuration, the capacity of the training data storage unit 13 that stores the training data can be reduced.

### Embodiment 2

In Embodiment 1 the degree of reliability of the inference result is estimated on the basis of the degree of similarity between the surrounding environment information which is the output result of the sensor 2, and the training data which has been used for the learning of the machine learning algorithm; however, in Embodiment 2 the degree of reliability of an inference result is estimated on the basis of a trial result provided when a machine learning algorithm is tried in advance.

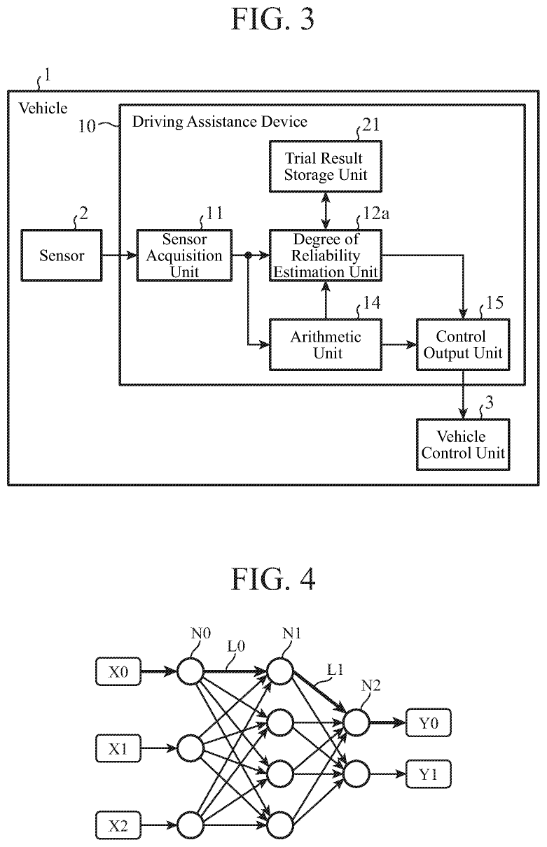

FIG. 3 is a block diagram showing an example of the configuration of a driving assistance device 10 according to Embodiment 2. The driving assistance device 10 according to Embodiment 2 includes, instead of the degree of reliability estimation unit 12 and the training data storage unit 13 in the driving assistance device 10 of Embodiment 1 shown in FIG. 1, a degree of reliability estimation unit 12a and a trial result storage unit 21. In FIG. 3, components which are the same as or equivalent to those shown in FIG. 1 are denoted by the same reference signs, and an explanation of the components will be omitted hereinafter.

The trial result storage unit 21 stores the trial result provided when the machine learning algorithm which an arithmetic unit 14 has is tried. The trial result is, for example, the number of times that each of routes from the input to the output in a neural network which constructs the machine learning algorithm is used when this machine learning algorithm is tried before the machine learning algorithm is set to the arithmetic unit 14.

FIG. 4 is a diagram showing an example of the configuration of the multilayer neural network which the arithmetic unit 14 has in Embodiment 2. In FIG. 4, it is assumed that the machine learning algorithm is the multilayer neural network having three layers. Further, it is assumed that an input layer consists of three nodes including a node N0, a middle layer consists of four nodes including a node N1, and an output layer consists of two nodes including a node N2. Pieces of surrounding environment information X0, X1, and X2 are inputted to the respective nodes of the input layer of the multilayer neural network. Further, inference results Y0 and Y1 are outputted from the respective nodes of the output layer of the multilayer neural network.

At the time of learning of the multilayer neural network shown in FIG. 4, the weight of a link connecting nodes (e.g., a link L0 connecting the node N0 and the node N1) is optimized in such a way that the inference results Y0 and Y1 which are pieces of training data are outputted when the pieces of surrounding environment information X0, X1, and X2 which are pieces of training data are inputted. Further, at the time of trial of the multilayer neural network after the learning, the number of uses which is the number of times that each of the routes from the input to the output in this multilayer neural network is used is collected, and the route and the number of uses are stored in the trial result storage unit 21 as a trial result in which the route and the number of uses are associated with each other. One of the routes from the input to the output is, for example, a route extending from the node N0, via the link L0, the node N1, and the link L1, to the node N2. Here, a “use” refers to a state in which the absolute values of outputs of a fixed number or more of nodes on a route are equal to or greater than a predetermined threshold. For example, when the total number of nodes on each of the routes is “10”, the fixed number is “8”, and the threshold is “0.6”, a route having eight or more nodes whose outputs are 0.6 or more is counted as “used.”

FIG. 5 is a flowchart showing an example of operations of the driving assistance device 10 according to Embodiment 2. When, for example, the ignition switch of a vehicle 1 is turned on, the driving assistance device 10 starts the operations shown in the flowchart of FIG. 5, and repeats the operations until the ignition switch is turned off.

An operation in step ST11 of FIG. 5 is the same as that in step ST11 of FIG. 2.

In step ST12, the arithmetic unit 14 calculates an inference result for controlling the vehicle 1 by using the machine learning algorithm in which surrounding environment information from a sensor acquisition unit 11 is set as an input, like that of Embodiment 1.

Further, in Embodiment 2, the arithmetic unit 14 outputs, to the degree of reliability estimation unit 12a, arithmetic process information indicating a route from the input to the output in the neural network which constructs the machine learning algorithm, the route being used when the arithmetic unit 14 calculates the inference result. For example, when the arithmetic unit 14 uses the route extending from the node N0, via the link L0, the node N1, and the link L1, to the node N2 shown in FIG. 4 when calculating the inference result Y0, this means that the weights of the links L0 and L1 exert an influence upon the inference result Y0. Therefore, the arithmetic unit 14 outputs this route as the arithmetic process information to the degree of reliability estimation unit 12a.

In step ST21, the degree of reliability estimation unit 12a selects, from the number of uses of each route stored in the trial result storage unit 21, the number of uses of a route matching the route from the input to the output which is based on the arithmetic process information from the arithmetic unit 14. The degree of reliability estimation unit 12a estimates the degree of reliability of the inference result calculated by the arithmetic unit 14 on the basis of the number of uses selected from the trial result storage unit 21.

The larger the number of uses, the higher degree of reliability of the inference result the degree of reliability estimation unit 12a estimates. For example, the degree of reliability estimation unit 12a estimates a degree of reliability of discrete type (e.g., a degree of reliability ranging from level 1 to level 5) by making a comparison between the number of uses and a predetermined threshold. As an alternative, the degree of reliability estimation unit 12a may perform a polynomial transformation process on the number of uses, to estimate a degree of reliability of continuous type (e.g., a degree of reliability ranging from 0% to 100%).

An operation in step ST15 of FIG. 5 is the same as that in step ST15 of FIG. 2.

As mentioned above, the degree of reliability estimation unit 12a of Embodiment 2 estimates the degree of reliability of an inference result on the basis of the number of uses corresponding to one of routes from the input to the output in the neural network by using information indicating the number of uses of each of the routes from the input to the output in the neural network when the machine learning algorithm is tried, the one of the routes being used when the arithmetic unit 14 calculates the inference result, the neural network constructing the machine learning algorithm. With this configuration, the driving assistance device 10 can estimate the degree of reliability of the arithmetic operation process of the machine learning algorithm. Therefore, when the degree of reliability of the inference result of the machine learning algorithm is low because of insufficient learning or the like, the driving assistance device 10 can suppress the occurrence of an unexpected behavior of the vehicle 1.

Although in the above-mentioned example the degree of reliability estimation unit 12a estimates the degree of reliability of the inference result by using the number of uses of a route from the input to the output in the neural network, no limitation is intended to this estimation method. For example, the degree of reliability estimation unit 12a may compare a predetermined distribution of an inference result with a distribution of an inference result calculated by the arithmetic unit 14, and estimate the degree of reliability of the inference result calculated by the arithmetic unit 14 on the basis of the degree of match between them. The predetermined distribution of an inference result is, for example, a relative frequency distribution based on a large number of inference results outputted at the time of trial of the machine learning algorithm, and is stored in the trial result storage unit 21.

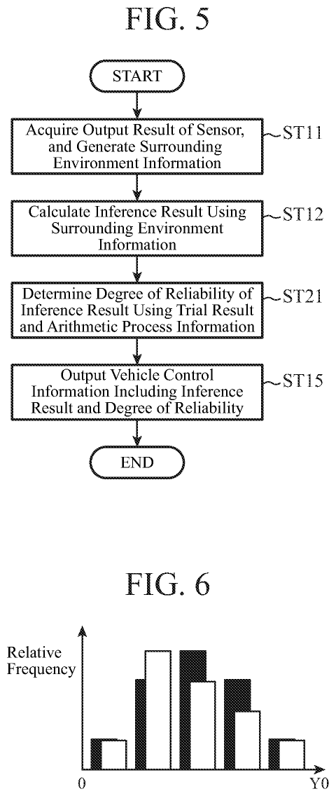

FIG. 6 is a relative frequency distribution graph showing an example of the distribution of an inference result in Embodiment 2. In the graph of FIG. 6, the horizontal axis shows values of the inference result Y0, and the vertical axis shows the relative frequency of each of the values of the inference result Y0. Further, black bars show a predetermined relative frequency distribution of an inference result, and white bars show a relative frequency distribution based on inference results which the arithmetic unit 14 calculates during the latest predetermined period of time. The higher the degree of match between the relative frequency distributions, the higher degree of reliability of the inference result the degree of reliability estimation unit 12a estimates. For example, the degree of reliability estimation unit 12a estimates a degree of reliability of discrete type (e.g., a degree of reliability ranging from level 1 to level 5) by making a comparison between the degree of match and a predetermined threshold. As an alternative, the degree of reliability estimation unit 12a may perform a polynomial transformation process on the degree of match, to estimate a degree of reliability of continuous type (e.g., a degree of reliability ranging from 0% to 100%).

### Embodiment 3

In Embodiment 3, the degree of similarity between surrounding environment information which is an output result of a sensor 2, and training data which has been used for learning of a machine learning algorithm is corrected on the basis of the degree of complexity of the surrounding environment information.

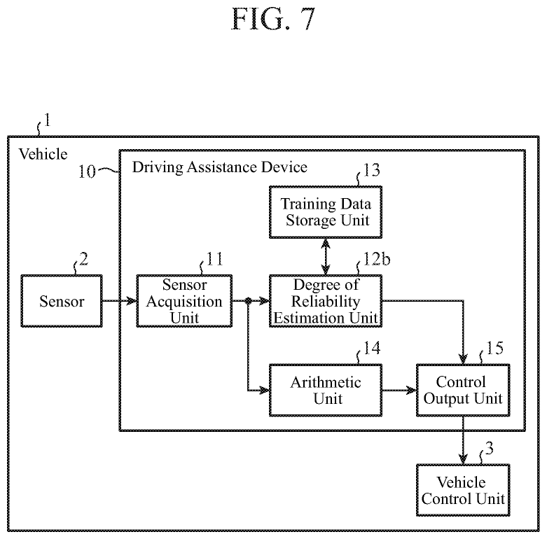

FIG. 7 is a block diagram showing an example of the configuration of a driving assistance device 10 according to Embodiment 3. The driving assistance device 10 according to Embodiment 3 includes, instead of the degree of reliability estimation unit 12 in the driving assistance device 10 of Embodiment 1 shown in FIG. 1, a degree of reliability estimation unit 12b. In FIG. 7, components which are the same as or equivalent to those shown in FIG. 1 are denoted by the same reference signs, and an explanation of the components will be omitted hereinafter.

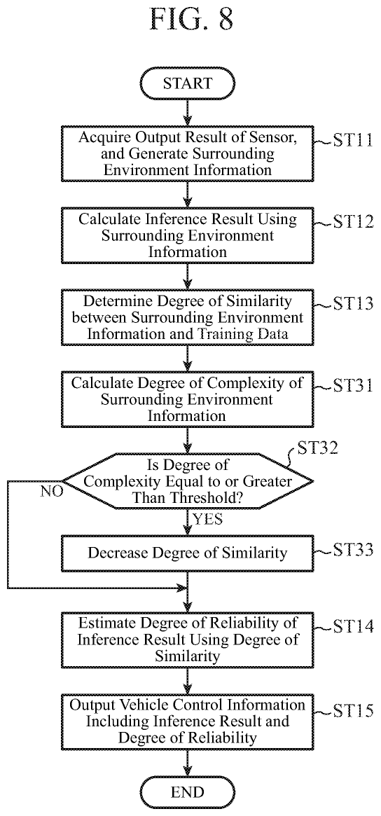

FIG. 8 is a flowchart showing an example of operations of the driving assistance device 10 according to Embodiment 3. When, for example, the ignition switch of a vehicle 1 is turned on, the driving assistance device 10 starts the operations shown in the flowchart of FIG. 8, and repeats the operations until the ignition switch is turned off.

Operations in steps ST11, ST12, and ST13 of FIG. 8 are the same as those in steps ST11, ST12, and ST13 of FIG. 2.

In step ST31, the degree of reliability estimation unit 12b calculates the degree of complexity of surrounding environment information from a sensor acquisition unit 11.

For example, the degree of reliability estimation unit 12b may calculate the degree of complexity on the basis of the entropy (e.g., the white noise of a captured image) of information which the sensor acquisition unit 11 acquires from the sensor 2, or may calculate the degree of complexity on the basis of the number of objects in the vicinity of the vehicle 1, the objects being recognized by the sensor acquisition unit 11, or the like.

In step ST32, the degree of reliability estimation unit 12b compares the degree of complexity with a predetermined threshold. When the degree of complexity is equal to or greater than the above-mentioned predetermined threshold (when “YES” in step ST32), the degree of reliability estimation unit 12b, in step ST33, performs a correction to decrease the degree of similarity. For example, the degree of reliability estimation unit 12b calculates a decrease value with a magnitude proportional to the degree of complexity of the surrounding environment information, and subtracts the calculated decrease value from the degree of similarity determined in step ST13. In next step ST14, the degree of reliability estimation unit 12b estimates the degree of reliability of an inference result calculated by an arithmetic unit 14 on the basis of the degree of similarity after decreased. Therefore, when the degree of complexity of the surrounding environment information is large, the degree of similarity decreases and the degree of reliability also decreases as a result.

In contrast, when the degree of complexity is less than the above-mentioned predetermined threshold (when “NO” in step ST32), the degree of reliability estimation unit 12b, in step ST14, estimates the degree of reliability of the inference result calculated by the arithmetic unit 14 on the basis of the degree of similarity determined in step ST13.

As mentioned above, the degree of reliability estimation unit 12b of Embodiment 3 calculates the degree of complexity of an output result of the sensor 2 acquired by the sensor acquisition unit 11, and corrects the degree of similarity on the basis of the degree of complexity of the output result. With this configuration, the driving assistance device 10 can estimate the degree of reliability of an inference result with a higher degree of accuracy.

### Embodiment 4

In Embodiment 4, the degree of similarity between surrounding environment information which is an output result of a sensor 2 and training data which has been used for learning of a machine learning algorithm is corrected on the basis of attribution information about the surrounding environment information and attribution information about the training data.

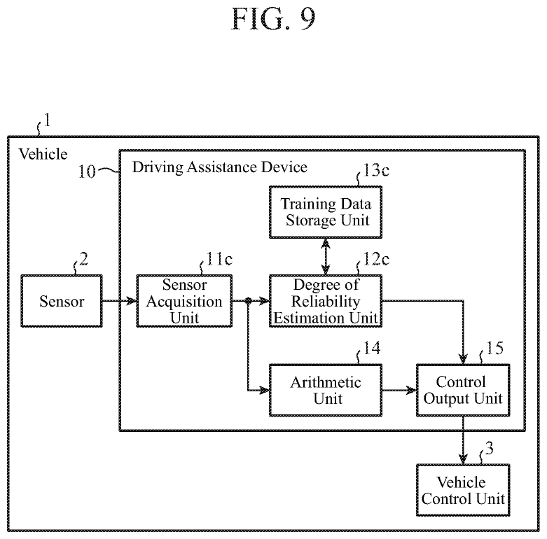

FIG. 9 is a block diagram showing an example of the configuration of a driving assistance device 10 according to Embodiment 4. The driving assistance device 10 according to Embodiment 4 includes, instead of the sensor acquisition unit 11, the degree of reliability estimation unit 12, and the training data storage unit 13 in the driving assistance device 10 of Embodiment 1 shown in FIG. 1, a sensor acquisition unit 11c, a degree of reliability estimation unit 12c, and a training data storage unit 13c. In FIG. 9, components which are the same as or equivalent to those shown in FIG. 1 are denoted by the same reference signs, and an explanation of the components will be omitted hereinafter.

The training data storage unit 13c stores pieces of training data which have been used at the time of learning of the machine learning algorithm which an arithmetic unit 14 has, and pieces of attribution information about the pieces of training data. The training data storage unit 13c may store feature quantities of the pieces of training data, instead of the pieces of training data.

The attribution information includes at least one of information about a date and time that training data is acquired, information about weather when the training data is acquired, or geographic information when the training data is acquired. The date and time information maybe a time expressed in seconds, minutes, and so on, or may be a time section such as morning or night. The weather information may be a category such as fine weather, rainy weather, or cloudy weather, or may be a numerical value such as an atmospheric pressure or a wind velocity. The geographic information may be a numerical value such as latitude and longitude, or may be a category such as a highway or an urban area.

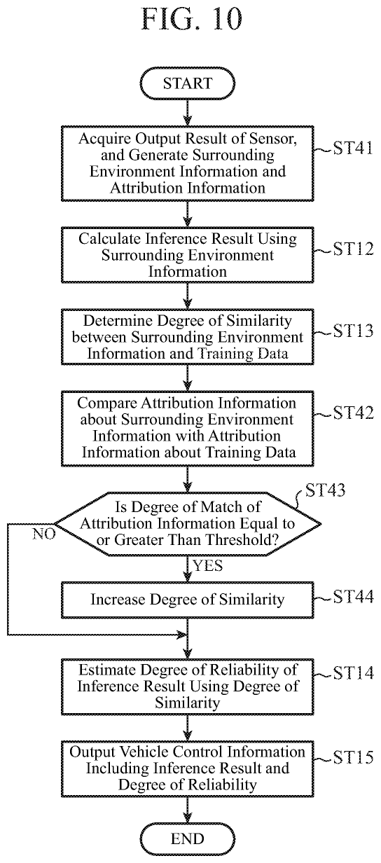

FIG. 10 is a flowchart showing an example of operations of the driving assistance device 10 according to Embodiment 4. When, for example, the ignition switch of a vehicle 1 is turned on, the driving assistance device 10 starts the operations shown in the flowchart of FIG. 10, and repeats the operations until the ignition switch is turned off.

In step ST41, as in Embodiment 1, the sensor acquisition unit 11c acquires information detected by the sensor 2, and generates surrounding environment information indicating a surrounding environment of the vehicle 1 by integrating the acquired information.

Further, in Embodiment 4, the sensor acquisition unit 11c acquires at least one of the date and time information, the weather information, or the geographic information from the sensor 2, and defines the acquired information as attribution information. The sensor acquisition unit 11c outputs the surrounding environment information to the arithmetic unit 14, and outputs the surrounding environment information and the attribution information to the degree of reliability estimation unit 12c. The sensor acquisition unit 11c may acquire attribution information from a car navigation device, a server device outside the vehicle, or the like, instead of acquiring attribution information from the sensor 2.

Operations in steps ST12 and ST13 of FIG. 10 are the same as those in steps ST12 and ST13 of FIG. 2.

In step ST42, the degree of reliability estimation unit 12c compares the attribution information from the sensor acquisition unit llc with the pieces of attribution information about the pieces of training data stored in the training data storage unit 13c. When the number of pieces of training data each having attribution information matching that about the surrounding environment information (i.e., the degree of match of attribution information) is equal to or greater than a predetermined threshold (when “YES” in step ST43), the degree of reliability estimation unit 12c, in step ST44, performs a correction to increase the degree of similarity. For example, the degree of reliability estimation unit 12c calculates an increase value with a magnitude proportional to the degree of match of attribution information, and adds the calculated increase value to the degree of similarity determined in step ST13. In next step ST14, the degree of reliability estimation unit 12c estimates the degree of reliability of an inference result calculated by the arithmetic unit 14 on the basis of the degree of similarity after increased. Therefore, when the attribution information about the surrounding environment information matches the pieces of attribution information about pieces of training data, the degree of similarity increases and the degree of reliability also increases as a result.

In contrast, when the degree of match of attribution information is less than the above-mentioned predetermined threshold (when “NO” in step ST43), the degree of reliability estimation unit 12c, in step ST14, estimates the degree of reliability of the inference result calculated by the arithmetic unit 14 on the basis of the degree of similarity determined in step ST13.

As mentioned above, the degree of reliability estimation unit 12c of Embodiment 4 compares at least one of the date and time information, the weather information, or the geographic information when the sensor acquisition unit 11c acquires the output result of the sensor 2, with at least one of the pieces of date and time information, the pieces of weather information, or the pieces of geographic information about piece of training data, and corrects the degree of similarity. With this configuration, the driving assistance device 10 can estimate the degree of reliability of an inference result with a higher degree of accuracy.

In Embodiment 4, the example in which the machine learning algorithm of the arithmetic unit 14 is learned using pieces of training data having various types of pieces of date and time information, weather information, and geographic information is explained; however, a machine learning algorithm may be learned as to each type of attribution information such as date and time, weather, or geography. In this case, the arithmetic unit 14 has a machine learning algorithm for each type of attribution information. This arithmetic unit 14 acquires the attribution information about the surrounding environment information from the sensor acquisition unit 11c, and calculates an inference result by using the machine learning algorithm provided for the attribution information matching the acquired attribution information. The degree of reliability estimation unit 12c has only to determine the degree of similarity between the surrounding environment information and training data having the attribution information matching the attribution information about this surrounding environment information, and estimate the degree of reliability on the basis of the determined degree of similarity. In this case, the degree of reliability estimation unit 12c does not have to correct the degree of similarity on the basis of the degree of match of attribution information.

As a concrete example, it is assumed that the sensor acquisition unit 11c generates surrounding environment information when it is raining. In this case, the arithmetic unit 14 calculates an inference result by using a machine learning algorithm which is learned using pieces of training data at the time of rain. The degree of reliability estimation unit 12c calculates the degree of similarity by comparing the surrounding environment information when it is raining with the above-mentioned pieces of training data at the time of rain, and estimates the degree of reliability on the basis of the calculated degree of similarity.

At least one of Embodiment 2, Embodiment 3, or Embodiment 4 may be combined with Embodiment 1.

Hereinafter, an example in which Embodiment 1 and Embodiment 2 are combined will be explained. For example, the degree of reliability estimation unit 12 determines the degree of similarity between the surrounding environment information from the sensor acquisition unit 11 and the training data stored in the training data storage unit 13, and estimates the degree of reliability of an inference result on the basis of the degree of similarity, like that of Embodiment 1. Next, the degree of reliability estimation unit 12 estimates the degree of reliability of the inference result by using the trial result stored in the trial result storage unit 21, like that of Embodiment 2. Then, the degree of reliability estimation unit 12 calculates a final degree of reliability by using both the degree of reliability estimated using the method of Embodiment 1 and the degree of reliability estimated using the method of Embodiment 2, and outputs the final degree of reliability to the control output unit 15. For example, the degree of reliability estimation unit 12 calculates, as the final degree of reliability, the average of the degree of reliability estimated using the method of Embodiment 1 and the degree of reliability estimated using the method of Embodiment 2.

Finally, the hardware configuration of the driving assistance device 10 according to each of the embodiments will be explained.

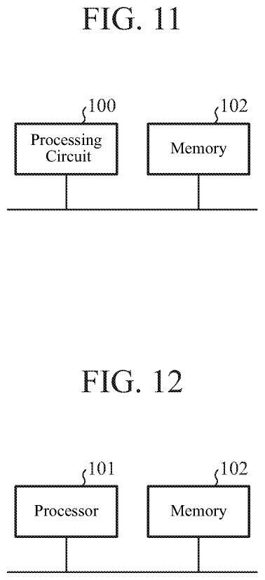

FIGS. 11 and 12 are diagrams showing examples of the hardware configuration of the driving assistance device 10 according to each of the embodiments. The training data storage unit 13 or 13c and the trial result storage unit 21 in the driving assistance device 10 correspond to a memory 102. The functions of the sensor acquisition unit 11 or 11c, the degree of reliability estimation unit 12, 12a, 12b, or 12c, the arithmetic unit 14, and the control output unit 15 in the driving assistance device 10 are implemented by a processing circuit. More specifically, the driving assistance device 10 includes a processing circuit for implementing the above-mentioned functions. The processing circuit maybe a processing circuit 100 as hardware for exclusive use or a processor 101 that executes a program stored in the memory 102.

In the case where the processing circuit is hardware for exclusive use, as shown in FIG. 11, the processing circuit 100 is, for example, a single circuit, a composite circuit, a programmable processor, a parallel programmable processor, an application specific integrated circuit (ASIC), a field programmable gate array (FPGA), or a combination thereof. The functions of the sensor acquisition unit 11 or 11c, the degree of reliability estimation unit 12, 12a, 12b, or 12c, the arithmetic unit 14, and the control output unit 15 may be implemented by multiple processing circuits 100, or may be implemented collectively by a single processing circuit 100.

In the case where the processing circuit is the processor 101, as shown in FIG. 12, the functions of the sensor acquisition unit 11 or 11c, the degree of reliability estimation unit 12, 12a, 12b, or 12c, the arithmetic unit 14, and the control output unit 15 are implemented by software, firmware, or a combination of software and firmware. The software or the firmware is described as a program and the program is stored in the memory 102. The processor 101 implements the function of each of the units by reading and executing the program stored in the memory 102. More specifically, the driving assistance device 10 includes the memory 102 for storing a program by which the steps shown in the flowchart of FIG. 2 or the like are performed as a result when the program is executed by the processor 101. Further, it can be said that this program causes a computer to perform procedures or methods of the sensor acquisition unit 11 or 11c, the degree of reliability estimation unit 12, 12a, 12b, or 12c, the arithmetic unit 14, and the control output unit 15.

Here, the processor 101 is a central processing unit (CPU), a processing device, an arithmetic device, a microprocessor, or the like.

The memory 102 may be a non-volatile or volatile semiconductor memory such as a random access memory (RAM), a read only memory (ROM), an erasable programmable ROM (EPROM), or a flash memory, a magnetic disc such as a hard disc or a flexible disc, or an optical disc such as a compact disc (CD) or a digital versatile disc (DVD).

Part of the functions of the sensor acquisition unit 11 or 11c, the degree of reliability estimation unit 12, 12a, 12b, or 12c, the arithmetic unit 14, and the control output unit 15 may be implemented by hardware for exclusive use, and part of the functions may be implemented by software or firmware. As mentioned above, the processing circuit in the driving assistance device 10 can implement the above-mentioned functions by using hardware, software, firmware, or a combination thereof.

Further, although in the above-mentioned example the functions of the sensor acquisition unit 11 or 11c, the degree of reliability estimation unit 12, 12a, 12b, or 12c, the training data storage unit 13 or 13c, the arithmetic unit 14, the control output unit 15, and the trial result storage unit 21 gather in the driving assistance device 10 which is a vehicle-mounted device, the functions maybe distributed among a server device on a network, a mobile information terminal such as a smartphone, a vehicle-mounted device, and so on. For example, a driving assistance system is constructed by a server device including the degree of reliability estimation unit 12, 12a, 12b, or 12c, the training data storage unit 13 or 13c, the arithmetic unit 14, and the trial result storage unit 21, and a vehicle-mounted device including the sensor acquisition unit 11 or 11c and the control output unit 15.

It is to be understood that any combination of two or more of the above-mentioned embodiments can be made, various changes can be made in any component according to any one of the above-mentioned embodiments, or any component according to any one of the above-mentioned embodiments can be omitted within the scope of the present disclosure.

### INDUSTRIAL APPLICABILITY

Because the driving assistance device according to the present disclosure estimates the degree of reliability of machine learning, the driving assistance device is suitable for use as driving assistance devices using machine learning, and so on.

### REFERENCE SIGNS LIST

1 vehicle, 2 sensor, 3 vehicle control unit, 10 driving assistance device, 11, 11c sensor acquisition unit, 12, 12a, 12b, 12c reliability estimation unit, 13, 13c training data storage unit, 14 arithmetic unit, 15 control output unit, 21 trial result storage unit, 100 processing circuit, 101 processor, 102 memory, L0, L1 link, N0, N1, N2 node, X0, X1, X2 surrounding environment information, and Y0, Y1 inference result.

1. A driving assistance device comprising:
processing circuitry
to acquire an output result of a sensor mounted in a vehicle;
to use a machine learning algorithm in which the acquired output result is set as an input, to calculate an inference result for controlling the vehicle;
to estimate a degree of reliability of the calculated inference result; and
to add the estimated degree of reliability to the calculated inference result, and output the inference result with the degree of reliability as vehicle control information.

2. The driving assistance device according to claim 1, wherein the processing circuitry determines a degree of similarity between the acquired output result and training data which has been used for learning of the machine learning algorithm, and estimates the degree of reliability of the calculated inference result on a basis of the degree of similarity.

3. The driving assistance device according to claim 1, wherein the processing circuitry estimates the degree of reliability of the inference result on a basis of the number of uses corresponding to one of routes from an input to an output in a neural network by using information indicating the number of uses of each of the routes from the input to the output in the neural network when the machine learning algorithm is tried, the one of the routes being used when the processing circuitry calculates the inference result, the neural network constructing the machine learning algorithm.

4. The driving assistance device according to claim 1, wherein the processing circuitry estimates the degree of reliability of the inference result on a basis of a degree of match between a predetermined distribution of an inference result and a distribution of the inference result calculated by the processing circuitry.

5. The driving assistance device according to claim 2, wherein the processing circuitry calculates a degree of complexity of the acquired output result, and corrects the degree of similarity on a basis of the degree of complexity of the output result.

6. The driving assistance device according to claim 2, wherein the processing circuitry determines a degree of similarity between a feature quantity of the acquired output result and a feature quantity of the training data.

7. The driving assistance device according to claim 2, wherein the processing circuitry compares information about a date and time that the processing circuitry acquires the output result, with date and time information about the training data, to correct the degree of similarity.

8. The driving assistance device according to claim 2, wherein the processing circuitry compares information about weather when the processing circuitry acquires the output result, with weather information about the training data, to correct the degree of similarity.

9. The driving assistance device according to claim 2, wherein the processing circuitry compares geographic information when the processing circuitry acquires the output result, with geographic information about the training data, to correct the degree of similarity.

10. A driving assistance method comprising:
acquiring an output result of a sensor mounted in a vehicle;
using a machine learning algorithm in which the acquired output result is set as an input, to calculate an inference result for controlling the vehicle;
estimating a degree of reliability of the calculated inference result; and
adding the estimated degree of reliability to the calculated inference result, and outputting the inference result with the degree of reliability as vehicle control information.
